(19) United States
(12) Patent Application Publication
(10) Pub. No.: US 2015/0356295 A1
(43) Pub. Date: Dec. 10, 2015

(54) KEEP-ALIVE SYSTEM AND METHOD FOR CLOUD-BASED DATABASE SYSTEMS

(71) Applicant: Royal Canadian Mint/Monnaie Royale Canadienne, Ottawa (CA)

(72) Inventor: David EVERETT, Rustington (GB)

(21) Appl. No.: 14/299,109

(22) Filed: Jun. 9, 2014

(51) Int. Cl. G06F 21/55; H04L 29/06; H04L 29/08

(52) U.S. Cl. CPC G06F 21/554; H04L 67/1097; H04L 63/20; G06F 2221/03

(57) ABSTRACT

A keep-alive system and method for cloud-based database systems. A plurality of fields of the database are monitored to track a predetermined pattern of changes with respect to time. A departure from the predetermined pattern of change indicates an unexpected action of the database such as, for example, a roll-back of the state of the database.

### CROSS-REFERENCE TO RELATED APPLICATIONS

This is the first application filed in respect of the present invention.

### MICROFICHE APPENDIX

Not Applicable.

### TECHNICAL FIELD

The present invention relates to secure storage and transfer of information, and in particular to a keep-alive system and method for cloud-based database systems.

### BACKGROUND

In the modern telecommunications space, so-called cloud-based services are becoming increasingly popular. Cloud-based services typically utilize a host server connected to a data network such as the Internet. The host server normally comprises one or more computer servers or server clusters maintained and operated by a cloud service provider. A client of the cloud service provider can access the host server to utilize various cloud-based computing and storage services available on the host server.

An example of cloud-based services includes an on-line cloud-hosted electronic payment system. In such a system, the host server may be used to store user account records, which may include information related to financial transactions of each user and an account balance.

Cloud-based services are attractive for electronic payment systems because the host servers offer very high availability and scalability, with the ability to process and store enormous amounts of information and handle multiple transactions simultaneously.

However, cloud-based services also suffer a limitation in that data stored on a host server is vulnerable to un-authorized access and other forms of misuse. This difficulty arises from the fact that a user must trust a legally unrelated party (in this case the cloud service provider) to ensure the security and integrity of the user's data. In order to address this, the user (or payment services provider) may use passwords or other authentication methods to try to control access to user account data. However, in this case, the authentication algorithms are executed on the host server, and the passwords and/or other authentication information will be received by the host server during a user log-on process. Users must therefore trust that the cloud service provider will not manipulate the authentication algorithms or misuse the authentication information provided by the user.

In addition, account data stored on the host server may be encrypted or otherwise cryptographically secured (for example by means of digital signatures and/or checksums), and messaging between users and the payment system may use encrypted messaging (such as Secure Socket Layer—SSL) to convey a user's financial information. However, in both of these cases the encryption algorithms are executed on the host server, and the keys will be stored on the host server at least for the duration of a user session. Users must therefore trust that the cloud service provider will not manipulate the encryption algorithms (e.g. to provide a “back-door”) or misuse the keys stored on the server during a user session. Applicant's co-pending US patent application entitled “Cloud-based Secure information storage and transfer system”, teaches a system that addresses this problem, by providing a secure data center which provides encryption and decryption services using keys that are securely stored in the data center. With this arrangement, user data can be cryptographically secured by the data center prior to be forwarded to the cloud host server for storage. This system is advantageous because data stored on the cloud host server is secured, but the secret keys and algorithms are never present on the cloud host server.

However, even when data stored in a cloud host server is cryptographically protected, it remains possible for a unauthorised actions to be taken to corrupt the data. For example consider a scenario in which a cyber-criminal is able to obtain access to the cloud host server using an administrator account. In this case, the cyber-criminal could trigger a “roll-back” of the state of the database. The roll-back function is a known administrative tool that has the effect of returning to state of the database to an earlier time, and is normally used to recover from some critical error. Because the roll-back operation affects all of state variables of the database, the fact that a roll-back operation had occurred may be undetectable by conventional security algorithms because the database state would still be consistent with cryptographic checksums. However, the content of the database would no longer be “fresh”, in that it would not properly reflect the effects of changes prior to the roll-back event. For a cyber-criminal able to obtain administrator access, this opens the possibility of using the roll-back operation to conceal the cyber-criminal's activities during a given period of time.

Techniques that address at least some of the above-noted limitations of the prior art remain highly desirable.

### SUMMARY

Accordingly, an aspect of the present invention provides a keep-alive system and method for cloud-based database systems. A plurality of fields of the database are monitored to track a predetermined pattern of change with respect to time. A departure from the predetermined pattern of change indicates an unexpected action of the database such as, for example, a roll-back of the state of the database.

By monitoring the time-domain changes in the database, the present technique is able to detect unexpected actions of the database, including roll-backs. This enables administrative and/or security personnel to investigate and take appropriate actions.

### BRIEF DESCRIPTION OF THE DRAWINGS

Further features and advantages of the present invention will become apparent from the following detailed description, taken in combination with the appended drawings, in which:

FIG. 1 schematically illustrates a representative database format usable in embodiments of the present invention;

FIG. 2 is a block diagram schematically illustrating a cloud-based system in which embodiment of the present invention may be implemented;

FIGS. 3A and 3B are message flow diagrams schematically illustrating a possible scenario for completing an e-commerce transaction in the cloud-based system of FIG. 2; and

FIGS. 4A and 4B are flowcharts schematically illustrating representative steps and process rules implemented in the methods of FIGS. 3A and 3B, and including methods in accordance with the present invention.

It will be noted that throughout the appended drawings, like features are identified by like reference numerals.

### DETAILED DESCRIPTION

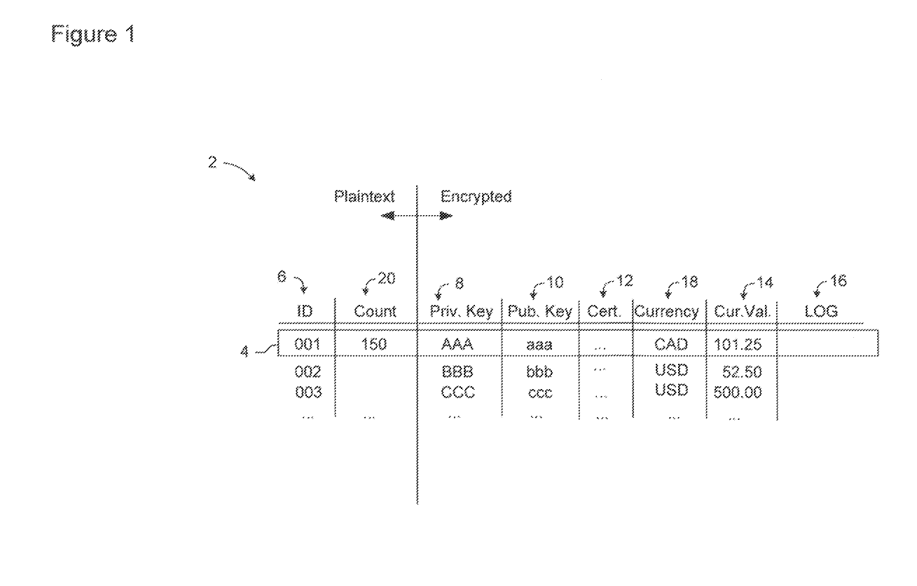

The present invention provides keep-alive system and method for cloud-based database systems. Embodiments of the invention are described below, by way of example only, with reference to FIGS. 1-4.

In the following description, the present invention will be described by way of an embodiment in which the present invention is used to enable detection of roll-backs of a database storing user account information in a cloud-based payments system. However, it will be recognised that the present invention is not limited to such embodiments, but rather that the same techniques may be used to detect improper operations in any database having one or more fields which exhibit a detectable pattern of state changes with respect to time during normal operation of the database.

Referring to FIG. 1, a representative format of a database 2 usable in a cloud-based payment system is shown although other formats may be used, if desired. In the embodiment of FIG. 1, the database 2 is formatted into records 4, each record 4 contains information regarding an account associated with a user. The record includes fields for storing the respective account ID 6, Private and Public Keys 8 and 10, and Certificate 12 uniquely assigned to the account, a current content (Cur.Val) 14 and a log 16. The Keys 8-10 and Certificate 12 enable cryptographic security of messaging for transferring monetary value to and from the respective account using, for example, well-known Public Key Infrastructure (PKI) techniques. The log 16 contains information relating to each transaction executed by or on behalf of the respective account. In some embodiments, this information may include the at least a portion of each value transfer message generated or received by the account, as will be described in greater detail below.

In some embodiments, each record 4 of the database 2 may also include a field identifying a currency 18 of the current value 14, and a count 20 of transactions that have been completed by (or on behalf of) the account represented by that record 4. Taken together, the contents of a record 4 provides the context of a respective account assigned to a user. Preferably, the ID field 6 is unencrypted, so that a payment application can readily use the account ID contained in received messages (as will be described in greater detail below) to retrieve a record 4 from the database 2 using well known techniques. Preferably, at least the Keys 8-10 and Certificate 12 are encrypted using one or more secret keys maintained independently of either the cloud-based payments system or the cloud host itself. In some embodiments, one or more other fields, such as the current value (Cur.Val) 14 and the log 16 are also encrypted. In some embodiments, un-encrypted fields may protected by means of cryptographic checksums and/or signatures, so as to prevent un-authorized changes in these fields. This arrangement is beneficial, in that it allows any given record 4 to be readily retrieved from the database 2, and updated using known techniques; but at the same time maintains security of the critical content of each record 4 by ensuring that it is computationally infeasible for any unauthorized party to read its secret data or modify its contents.

In the embodiment of FIG. 1, each database record 4 includes a count 20 of transactions that have been completed by or on behalf of the account represented by that record 4. It will be appreciated that the count value stored in this field must necessarily increase over time, as the owner of the account uses it for various transactions.

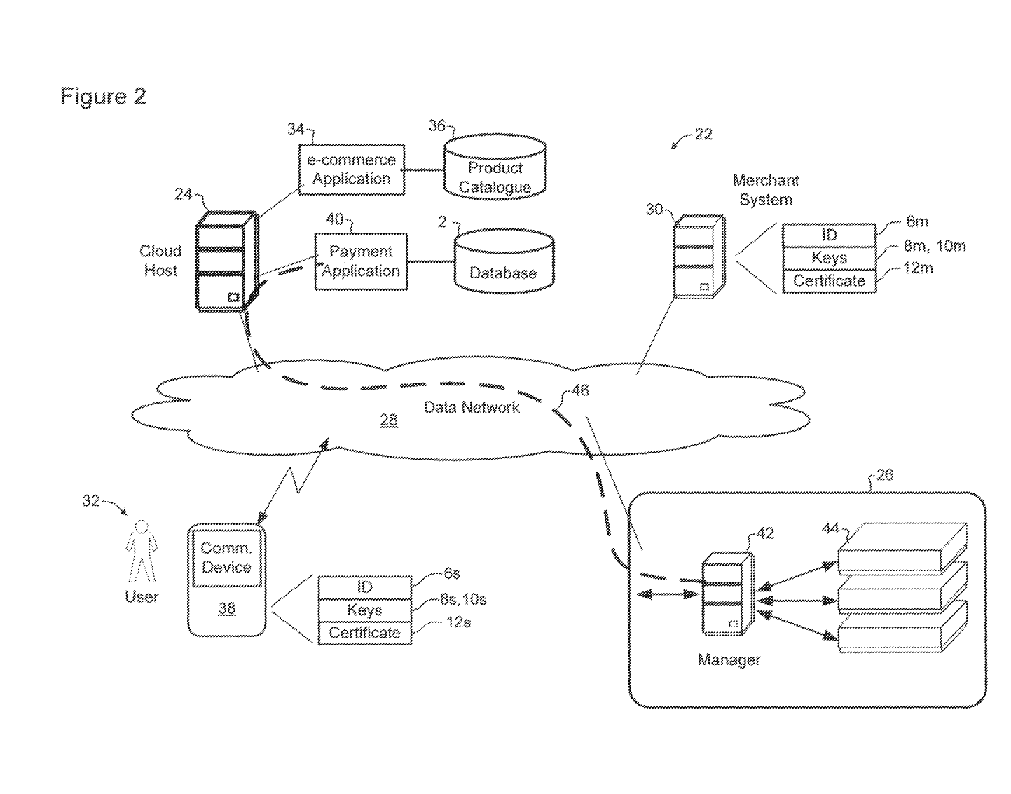

FIG. 2 illustrates a representative cloud-based system in which techniques in accordance with the present invention may be used. Referring to FIG. 2, a representative cloud-based secure information storage and transfer system 22 comprises a cloud host system 24 and secure data center 26, both of which are connected to a data network 28, such as, for example, the Internet. Merchant systems 30 and individual users 32 may interface with the cloud host system 24 to access and use cloud based applications, such as e-commerce applications, for example.

The cloud host system 24 may be managed by a cloud service provider and may comprise one or more servers or server clusters configured to provide computing and storage services to a plurality of subscribers of the cloud service provider. Cloud host systems of a type usable in the present technique are well known, and cloud hosted services are readily available from several cloud service providers (such as, for example, Amazon.com, and Google.com).

In the illustrated embodiment, a merchant may use the merchant system 30 to manage an e-commerce application 34 executing on the cloud host 24, and maintain a product catalogue database 36 stored on the cloud host 24. For example, an individual user 12 may use their communication device 38 to access the e-commerce application 34, which then may permit the user 32 to browse the catalogue 36 and select items the user 12 wishes to purchase. Once the user 32 has selected their items, the e-commerce application 34 may access a payment application 40 in order to complete the purchase transaction. The payment application may use the database 2 to obtain information of the user's and merchant's respective accounts, and to complete the transfer of monetary value between these accounts. The user's account ID 6s, private and public keys 8s-10s and certificate 12s may be saved on the user's communication device 38. Similarly, the merchant's account ID 6m, private and public keys 8m-10m and certificate 12m may be saved on the merchant system 30.

In the illustrated embodiment, a payment services provider manages both the payment application 40 and the data center 26, which generally comprises a manager 42 connected to one or more secure servers 44. In general, the manager 42 controls the flow of messages into and out of the data center 26. In some embodiments, the manager 42 distributes messaging across the secure servers 44, for example to provide load balancing or redirection in the event of a failure of one of the secure servers 44. In some embodiments, the manager 42 may also provide encryption and decryption services, as will be described in greater detail below. In some embodiments, the manager 42 is provided as a Hardware Security Module (HSM) of a type known in the art and commercially available, and executing suitable software to implement the appropriate functionality. In some embodiments, each of the secure servers 44 within the data center 26 are provided as Hardware Security Modules (HSMs).

Security of the data center 26 is enhanced by configuring the manager 42 to only exchange messages with the Payment Application 40. One way of accomplishing this is to establish and maintain a secure connection 46 or Virtual Private Network (VPN) between the manager 42 and the Payment Application 40 using a known tunneling protocol, for example. With this arrangement, the manager 42 can be configured to accept and send messages through the secure connection 46, and to discard messages received via the data network 28 from any other source. The security of the data center 26 may also be enhanced by ensuring that the network address of the data center 26 is known only to the Payment Application 40, and is not advertised to the network 28.

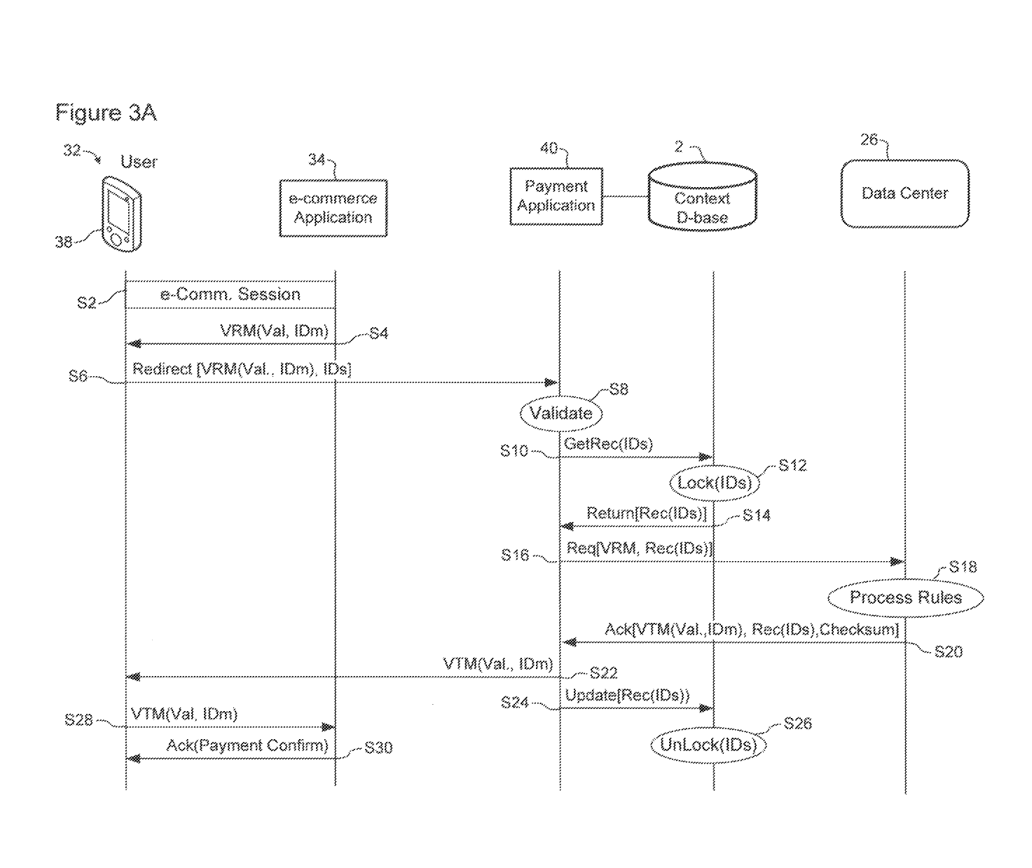

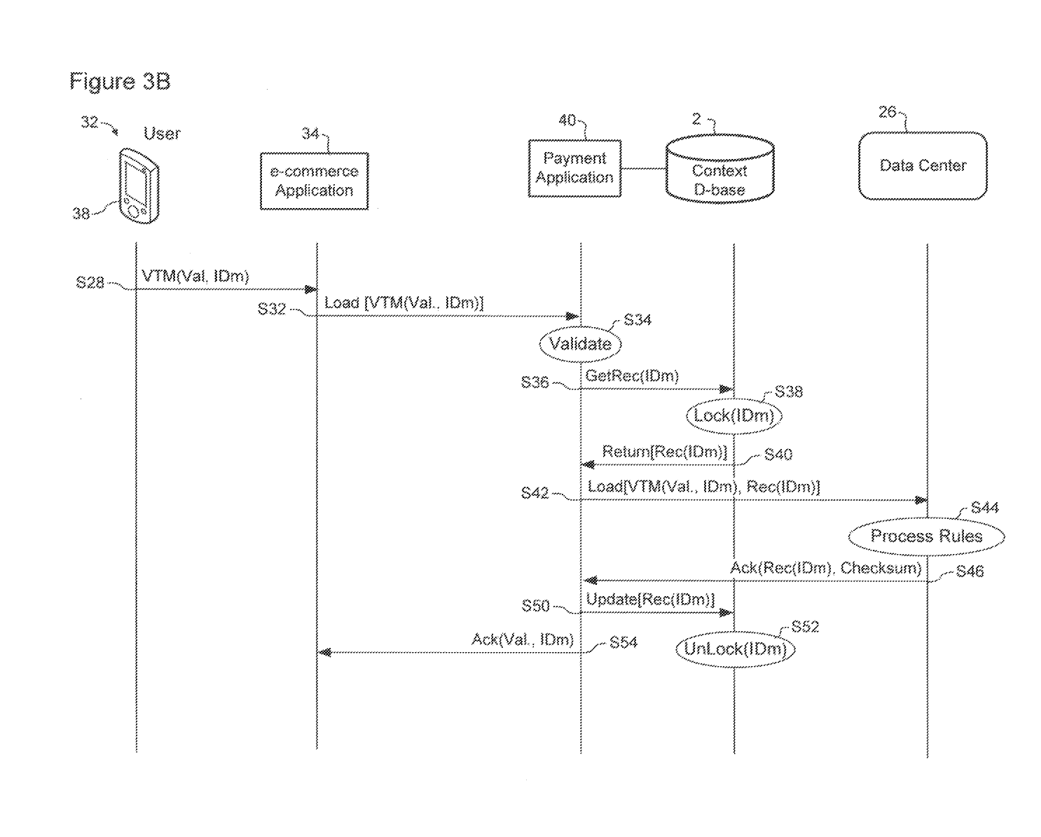

FIG. 3A is a message flow diagram illustrating an example operation of the Payment application 40 and data center 26 for completing an e-commerce transaction implemented in the system of FIG. 2. Referring to FIG. 3A, in a first step (S2), a user 32 uses their communications device 38 to access the merchant's e-commerce application 34, browse the merchant's product catalog 36, and select an item to purchase, all in a conventional manner. Based on the user's purchase selection, the e-commerce site 34 initiates a payment sequence, by formulating a Value Request Message (VRM) containing the merchant's account ID 6m as the intended recipient, and the payment amount owing as the content to be transferred, and sends this VRM to the user's communication device 38 (at S4). Upon receipt of the VRM, the subscriber's communication device 38 redirects the VRM to the Payment Application 40 (at S6). In some embodiments, the redirected VRM may also include the users account ID 6s and Certificate 12s.

Upon receipt of the redirected VRM from the user's communication device 38, the Payment Application 40 may perform verification process (at S8) to confirm the user's account ID 6s and Certificate 12s. In some embodiments, the Payment Application 40 may also attempt to obtain confirmation of the user's acceptance of the transaction. In some embodiments, the verification processes may be handled within secure connections (for example Secure Sockets Layer, SSL, connections) set up for this purpose between the Payment Application 40 and either one or both of the e-commerce application 34 and the Cloud Host 24. In some embodiments, the Payment Application 40 may obtain information of the transaction (e.g. user's account ID 6s and the transaction amount) from the e-commerce application 34. In some embodiments, the Payment Application 40 may obtain confirmation of the user's authentication status from either the cloud host 24 or the e-commerce application 34. In cases where the user 32 has already completed log-in and/or authentication processes with either or both of the cloud host 24 and the e-commerce application 34, it may not be necessary for the Payment Application 40 to request the user 32 to complete further authentication steps in order to complete the transaction. However, if desired, these further additional authentication steps may be performed using known techniques.

Upon successful completion of the verification process, the Payment Application 40 requests (at S10) the user's account record 4s from the database 2. Preferably, the database record 4s representing the users' account is locked (at S12) to prevent another process from accessing or revising that record before completion of the current transaction. In some embodiments, the record 4s may be locked by the database engine (not shown), in response to the request message from the Payment Application 40. In other embodiments, the record may be locked by the Payment Application 40 itself, for example by means of suitable control messages. Upon receipt of the subscriber's account record from the database 2 (at S14), the Payment Application 40 forwards the VRM and the user's account record (at S16) to the data center 26 for processing.

Upon receipt of the VRM and the subscriber's account record 6s, the manager 42 may decrypt the user's record using locally stored keys, and pass the VRM and the decrypted record to a secure server 44 for processing. Alternatively, the manager 42 may pass the encrypted record 4s and the VRM to a secure server 44, which will then decrypt the record prior to processing the VRM. In either of these embodiments, the secure server 44 processes the VRM and the decrypted context (S18) in accordance with a set of processing rules (described in greater detail below), to generate (S20) at least: a value transfer message (VTM) for conveying the payment amount owing to the Merchant and an updated version of the user's account record. These items are passed back to the manager 42 for forwarding to the Payment Application 40 (at step S20). In embodiments in which the secure server 44 performs encryption/decryption functions, at least a portion of the updated user's account record may be encrypted and/or secured using cryptographic checksums by the secure server 44 prior to passing them to the manager 42. In other embodiments, the manager 42 may encrypt and/or generate checksums securing portions of the updated account record prior to forwarding it to the Payment Application 40.

In some embodiments, the secure server 44 may also generate one or more checksums, signatures or other validation data, which may be passed to the manager 42 and/or the Payment Application 40 so that the integrity of the VTM and updated user's account record can be verified.

Upon receipt of the VTM and updated user's account record from the manager 42, the Payment Application 40 may forward the VTM to the subscriber's communication device 38 (at S22). The updated account record may then be stored (at S24) in the appropriate record 4 of the database 2, and that record unlocked (at S26) to permit other transactions

Upon receipt of the VTM from the Payment Application 40, the user's communication device 38 can forward the VTM to the e-commerce application 34 (at S28) in order to complete the transaction. A representative process for completing a transaction following receipt of the VTM by the e-commerce application 34 is described below with reference to FIG. 3B. Upon successful completion of that process, an acknowledgment message may be sent (at S30) to the user's communication device 38. A corresponding acknowledgment message may also be sent by the e-commerce application 34 to the Merchant's system 30.

Referring to FIG. 3B, when the e-commerce application 34 receives a VTM from a user's communication device 38 (at S28), it formulates and sends a load request message (at S32) containing the VTM to the Payment Application 40.

Upon receipt of the VTM from the e-commerce application 34, the Payment application 40 may perform a verification process (at S34) to confirm the integrity of the VTM. In some embodiments, the verification process may use the User's Certificate 12s and/or signature/checksums contained in the VTM to verify that the VTM content has not been changed since it was generated.

If the validation process fails, the payment application 40 may discard the VTM and the Load request message. In some embodiments, the payment application may return a failure notification message (not shown) to the e-commerce application 34.

Upon successful completion of the verification process, the Payment application 40 requests the Merchant's account record from the database 2 (at S36). Preferably, the database record 4m representing the Merchant's account is locked (at S38) to prevent another process from accessing or revising that record before completion of the current transaction. In some embodiments, the record may be locked by the database engine (not shown), in response to the request message from the Payment Application 40. In other embodiments, the record may be locked by the Payment application 40 itself, for example by means of suitable control messages. Upon receipt of the Merchant's account record from the database 2 (at S40), the Payment application 40 forwards the VTM and the Merchant's record 6m to the data center 26 (at S42) for processing.

Upon receipt of the VTM and the Merchant's record, the manager 42 may decrypt the Merchant's context, and pass the VTM and the decrypted record 4 to a secure server 44 for processing. Alternatively, the manager 42 may pass the encrypted record and the VTM to a secure server 44, which will then decrypt the record 4 prior to processing the VTM. In either of these embodiments, the secure server 44 processes (at S44) the VTM and the decrypted record 4 in accordance with a set of processing rules (described in greater detail below), to generate at least: an acknowledgment message indicating success or failure of the transaction; and an updated version of the Merchant's record 4m. These items are passed back to the manager 42 for forwarding to the Payment application 40 (at S46). In embodiments in which the secure server 44 performs encryption/decryption functions, at least a portion of the updated Merchant's record 4 may be encrypted by the secure server 44 prior to passing them to the manager 42. In other embodiments, the manager 32 may encrypt portions of the updated Merchant's record 4 prior to forwarding them to the Payment Application 20.

In some embodiments, the secure server 44 may also generate one or more checksums, signatures or other validation data, which may be passed to the manager 42 and/or the Payment application 40 so that the integrity of the updated merchant's record 4m can be verified.

Upon receipt of the Acknowledgment message and updated Merchant's record 4m from the manager 42, the Payment application 40 may store the updated Merchant's record 4m in the database 2 (at S50), and unlock that record (at S52) to permit other transactions. In a scenario in which the Acknowledgment message indicates that the transaction was successful, corresponding acknowledgment messages may be sent (at S54) to any one or more of the e-commerce application 34, the user's communication device 38 and/or the merchant system 30 to indicate that the transaction has been successfully completed. On the other hand, if the Acknowledgment message indicates that the transaction was not successful, the Payment application 40 may send failure messages to any one or more of the user's communication device 38, the merchant system 30, and the e-commerce application 34 so that the user's purchase may be cancelled or other steps taken to identify and rectify the problem.

In the process described above with reference to FIG. 3A, the secure server 44 processes a VRM and the user's record 4 in accordance with a set of processing rules at step S18, to generate at least a VTM, and an updated version of the user's account record 4s. Similarly, in the process described above with reference to FIG. 3B, the secure server 44 processes a VTM and the Merchant's record 4m in accordance with a set of processing rules at step S44, to generate at least an Acknowledgment message and an updated version of the Merchant's record 4m. Thus it will be seen that the secure server 44 is able to examine the respective count value 20 of the record 4 involved in any given transaction.

In the present technique, the count value 20 is particularly useful because in the normal course of operation it must necessarily increase monotonically with respect to time. This pattern of behaviour of the count value enables the evolution of the state of the database to be monitored in such a way that unexpected database actions, such as a roll-backs for example, can be detected.

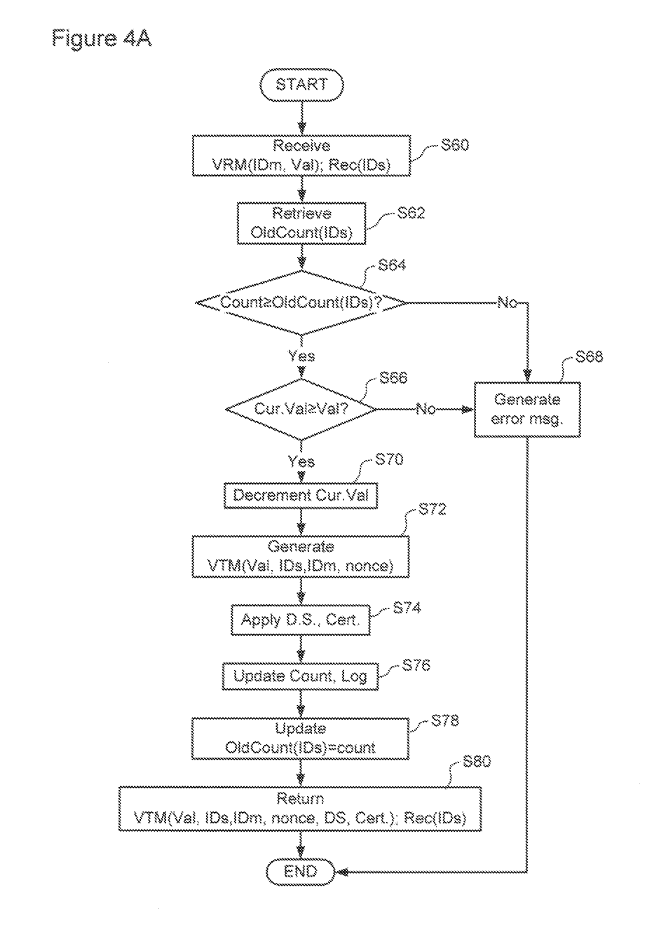

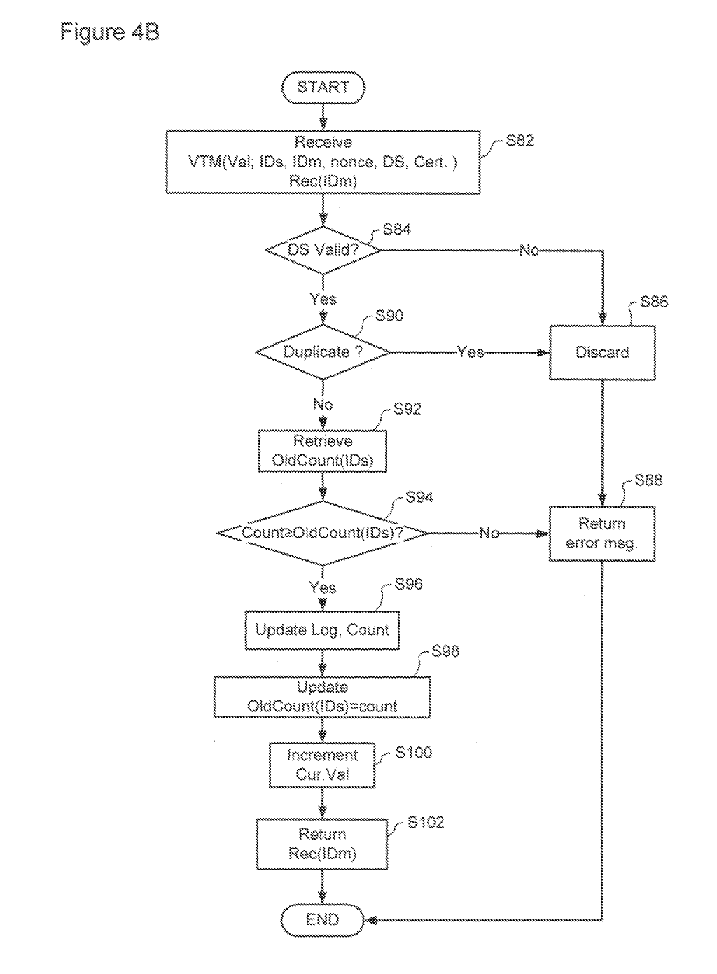

FIGS. 4A and 4B illustrate processing of the data center that incorporates one method of accomplishing this monitoring operation.

FIG. 4A is a flow chart illustrating representative processing rules for processing a VRM and a user's account record 4s, to generate a VTM and an updated version of the user's account record 4s, which is referenced at step S18 of FIG. 3A. As may be seen in FIG. 4A, the process begins with the secure server 44 receiving the VRM and decrypted user's account record 4s. Upon receipt of the VRM (at S60), the secure server 44 retrieves an old count value of the user's account stored in the data center 26 (step S62), and compares it to the count value 20 in the decrypted user's account record 4s. If the count value 20 is equal to, or greater than the old count value, then the proper behavior of the count value is confirmed, and the process may continue, Otherwise, an error message indicative of an improper database operation is generated and returned to the manager 42.

When the proper behavior of the count value is confirmed (at S64), the secure server 44 compares (at S66) the content (Val.) to be transferred with the current content (Cur.Val) 14 stored in the user's account record 4s. If Cur.Val 14 is less than the content to be transferred (Val.), then the secure server 44 generates and returns an error message (at S68). Otherwise, the secure server 44 decreases the Cur.Val 14 by the content (Val.) to be transferred (at S70), and then generates (at S72) a Value Transfer Message (VTM) containing the content (Val.) to be transferred, the ID 6s of the user′ account, the ID 6m of the merchant's account and a nonce which uniquely identifies the VTM, at least among the content transfer messages generated and sent on behalf of the user′ account. The secure server 44 then applies a Digital Signature (DS) and the user's Certificate 12s to the VTM (at S74). The secure server 44 then records information about the transfer in the Log field 16 of the user's account record 4s (at S76), and updates the user's old count value stored in the data center 26. Finally, the secure server 44 returns (at S80) the digitally signed VTM and the updated record 4s to the Manager 42.

FIG. 4B is a flow-chart illustrating representative processing rules for processing a received VTM message to load value to a subscriber's (in the illustrated example, the merchant's) account. Referring to FIG. 4B, the process begins with the secure server 44 receiving the VTM and decrypted Merchant's account record 4m from the manager 42. Upon receipt of the VTM (at S82), the secure server 44 uses the Certificate 12 to verify (at S84) the digital signature of the received VTM. If the verification fails, the VTM is discarded (at S86), and an error message is returned (at S88) to the Manager 42 before the process is terminated. If the verification is successful, the secure server 44 uses the nonce and both the user's account ID 6s and the merchant's account ID 6m to compare (at S90) the received VTM with the decrypted Merchant's log field 16m to determine whether the VTM is a duplicate of a VTM previously received from the user's account. If it is a duplicate, the VTM is discarded (at S86), an error message is returned to the Manager 42 (at S88) and the process is terminated. Otherwise, the secure server 44 retrieves an old count value of the merchant's account stored in the data center 26 (step S92), and compares it to the count value 20 in the decrypted user's account record 4s (at step S94). If the count value 20 is equal to, or greater than the old count value, then the proper behavior of the count value is confirmed, and the process may continue. Otherwise, an error message indicative of an improper database operation is generated and returned to the manager 42 (at step S88).

When the proper behavior of the count value is confirmed (at S94), the secure server 44 updates the merchant's log 14 with a transaction record including information about the transaction (at S96), updates the user's old count value stored in the data center 26 (at S98) and increases the current content (Curr.Val) 14 stored in the Merchant's record 4m by the content (Val.) contained in the VTM (at S100). Finally, the secure server 44 returns (at 5102) an acknowledgment message and the updated Merchant's account record 4m to the manager 42, indicating that the VTM message has been successfully processed.

In the embodiment of FIG. 4A, the count field value of the user's account record 4s is used to check for proper operation of the database (at S64). However, this is not essential, if desired, the merchant's count value may be used for this purpose.

In some embodiments, a subset of subscriber accounts may be selected and monitored to track the evolving state of the database. For example, it is contemplated that some subscriber accounts (such as the account of an individual user 12, for example) may be involved in transactions only infrequently, while others (such as a merchant, broker, or bank) may experience a large number of transactions within any given period of time. It is expected that subscriber accounts that experience a lot of activity (which may be referred to as “high-activity accounts”) will provide a more precise indication of the evolving state of the database. For example, the embodiments if FIGS. 4A and 4B may be modified to include a step of determined whether either of the involved accounts (as indicated by their respective account ID) are high-activity accounts, and if so, then selecting one (or both) high value account to check for proper operation of the database at steps S64 and S94.

In some embodiments, the data center may compute an aggregate function over a plurality of subscriber accounts. For example, in an embodiment that tracks count field values of high activity accounts, the data center may compute a running total of count field values, or a running average, or any other suitable function across the accounts being tracked. This arrangement can be beneficial in that an aggregate value computed across a plurality of subscriber accounts operates as a filter function to smooth out short period changes due to variations in the traffic loads experienced by any one subscriber account.

In the embodiments described above, the count field 20 is used to track the evolving state of the database with respect to time, and thereby detect unexpected actions of the database such as a roll-back. However, it will be appreciated that the present technique is not limited to such embodiments. Rather, any suitable field, combination of fields, or characteristic of the database which, under normal operation of the database, exhibits a known pattern of behaviour with respect to time, may be used.

The embodiment(s) of the invention described above is(are) intended to be exemplary only. The scope of the invention is therefore intended to be limited solely by the scope of the appended claims.

1. A method of detecting unexpected operation of a database in a cloud-based information storage system, the database comprising a plurality of records, at least a portion of each record being encrypted, the method comprising:
a processor monitoring a predetermined feature of the database which, under normal operation of the database, exhibits a known pattern of change with respect to time; and
the processor detecting the unexpected operation of the database as a deviation from the known pattern of change with respect to time.

2. The method of claim 1, wherein the feature of the database comprises any one or more of:
a value of a field of the database; and
a value calculated across a set of records of the database.

3. The method of claim 2, wherein the value of a field of the database comprises a count value.

4. The method of claim 3, wherein the known pattern of change with respect to time comprises a monotonically increasing value with respect to time.

5. The method of claim 1, wherein monitoring the identified feature comprises monitoring the identified feature for a subset of records of the database.

6. The method of claim 5, wherein the subset of records of the database comprise high-activity records.

7. A non-transitory computer-readable storage medium storing software instructions for controlling a processor to detect an unexpected operation of a database in a cloud-based information storage system, comprising:
software instructions configured to control the processor to monitor a predetermined feature of the database which, under normal operation of the database, exhibits a known pattern of change with respect to time; and
software instructions configured to control the processor to detect the unexpected operation of the database as a deviation from the known pattern of change with respect to time.

8. A cloud-based information storage system comprising:
a database comprising a plurality of records, at least a portion of each record being encrypted; and
a processor configured to detect unexpected operation of the database, by:
monitoring a predetermined feature of the database which, under normal operation of the database, exhibits a known pattern of change with respect to time; and
detecting the unexpected operation of the database as a deviation from the known pattern of change with respect to time.

9. The cloud-based information storage system of claim 8, wherein the feature of the database comprises any one or more of:
a value of a field of the database; and
a value calculated across a set of records of the database.

10. The cloud-based information storage system of claim 9, wherein the value of a field of the database comprises a count value.

11. The cloud-based information storage system of claim 10, wherein the known pattern of change with respect to time comprises a monotonically increasing value with respect to time.

12. The cloud-based information storage system of claim 8, wherein monitoring the identified feature comprises monitoring the identified feature for a subset of records of the database.

13. The cloud-based information storage system of claim 12, wherein the subset of records of the database comprise high-activity records.
